(19) United States
(12) Patent Application Publication
(10) Pub. No.: US 2025/0200459 A1
(43) Pub. Date: Jun. 19, 2025

(54) AUTOMATICALLY SELECTING PROVIDERS TO WHOM TO DIRECT REFERRALS USING SELECTION RULES SPECIFIED BY THE REFERRER

(71) Applicant: eXp Realty, LLC, Bellingham, WA (US)

(72) Inventors: Kurt Brooks Uhlir, Roswell, GA (US); Scott Graeme Lockhart, Atlanta, GA (US); Alan Scott Pinstein, Decatur, GA (US); Michael David Chatman, Marietta, GA (US); Scot Bohl, Takoma Park, MD (US); Spondon Kath Hazarika, Quincy, MA (US); Samuel Christopher Wade, Acworth, GA (US); Brian McKeough, Glenview, IL (US)

(21) Appl. No.: 18/545,707

(22) Filed: Dec. 19, 2023

(51) Int. Cl. G06Q 10/0631; G06Q 50/163

(52) U.S. Cl. CPC G06Q 10/06311; G06Q 50/163

(57) ABSTRACT

A facility for directing a services referral is described. The facility determines that a referral opportunity has arisen for a prospective referrer relating to a service opportunity for a consumer. The facility accesses one or more rules specified on behalf of the prospective referrer. The facility applies the accessed one or more rules to the referral opportunity to select one or more target providers, and causes the referral opportunity to be conveyed to one or more of the selected one or more target providers.

### CROSS-REFERENCE TO RELATED APPLICATIONS

This application is related to U.S. patent application Ser. No. 18/317,720, filed May 15, 2023 and entitled “AUTOMATICALLY ASSESSING REFERRALS,” which is hereby incorporated by reference in its entirety.

In cases where the present application conflicts with a document incorporated by reference, the present application controls.

### BACKGROUND

A referral involves a referrer conveying to a provider an opportunity to serve a consumer. For example, a first real estate agent may convey to a second real estate agent an opportunity to assist a prospect in acquiring property in a particular jurisdiction. In some cases, a provider may share with the referrer consideration received by the provider.

### BRIEF DESCRIPTION OF THE DRAWINGS

FIG. 1 is a block diagram showing some of the components typically incorporated in at least some of the computer systems and other devices on which the facility operates.

FIG. 2 is a flow diagram showing a process performed by the facility in some embodiments in order register a referrer.

FIG. 3 is a display diagram showing a sample display presented by the facility in some embodiments to receive input from a referrer configuring selection rules for the referrer.

FIG. 4 is a flow diagram showing a process performed by the facility in some embodiments to perform a referral for a particular opportunity.

FIG. 5 is display diagram showing a sample display presented by the facility in some embodiments to a provider who is eligible to receive referrals directed in accordance with the facility.

FIG. 6 is a block diagram showing a sample data ingestion system for a multiple listing system, used by the facility in some embodiments.

FIG. 7 is a block diagram showing a sample data ingestion system that accesses data from multiple MLSs, used by the facility in some embodiments.

FIG. 8 is a sample data flow diagram of MLS data showing the flow of MLS data in some embodiments.

FIG. 9 is a sample block diagram showing a MLS data normalization system, used by the facility in some embodiments.

FIG. 10 is a sample data flow diagram showing the flow of data used by a MLS compliance engine in some embodiments.

FIG. 11 is a sample block diagram showing one or more entities, systems, processes, functions, etc., that may access an MCE in some embodiments.

FIG. 12 is a sample block diagram showing a consumer home search platform, used by the facility in some embodiments.

FIG. 13 is a sample block diagram showing the interaction of the search platform with one or more other functions, services, systems, etc., of the facility in some embodiments.

FIG. 14 is a sample data flow diagram showing the flow of data between a content curation engine and other aspects of the facility in some embodiments.

FIG. 15 is a sample data flow diagram showing the flow of curated content data accessed by the CCE in some embodiments.

FIG. 16 is a sample data flow diagram showing the flow of data between a content sharing system, content platforms, and other aspects of the facility in some embodiments.

FIG. 17 is a flow diagram of a sample process to use a referral agreement system (“RAS”), used by the facility in some embodiments.

FIG. 18 is a sample block diagram of various systems, functions, components, services, etc., of the facility, including a real estate tracking system, used by the facility in some embodiments.

FIG. 19 is a sample block diagram of an embodiment of the facility that includes one or more of: a dashboard, a notification delivery platform, an affiliate advertising tracking platform, an MCE, an RCE, a CCE, a CSS, a data ingestion system, a data normalization system, an RETTS, an RAS, and other aspects of the facility.

### DETAILED DESCRIPTION

The inventors have recognized significant disadvantages in conventional referral techniques. In particular, the inventors have recognized that it is common for a referrer who has an opportunity that the referrer is not in a position to service themself to spend a great deal of time, and encounter significant difficulties, manually selecting a provider to whom to convey a referral of the opportunity. For example, such a referrer may have to manually (1) determine a jurisdiction to which the opportunity relates; (2) research licensing requirements that specify, for the jurisdiction, a level of licensing a provider must have in order to properly3ction3 the opportunity; (3) identify providers having the required level of licensing in the jurisdiction; (4) assess the level of competency of some or all of the identified providers to successfully service the opportunity; and/or (4) consider whether particular benefit may inure to the referrer for selecting particular service providers, such as those in the same organization, those who will benefit the most, those who are likely to be the most grateful, those who are likely to most reliably compensate the referrer or compensate the referrer to the greatest degree, etc. In some cases, this process involves a step of contacting other trusted providers and/or referrers to seek advice about selecting a provider to whom to convey a referral of the opportunity; this communication can take meaningful additional time and effort to complete.

The inventors have further recognized that, once the referrer has identified a service provider, it can be difficult to convey the opportunity to the selected service provider, involving communication via a variety of channels that may be attended to with various levels of diligence by the selected provider.

The inventors have additionally recognized that it can be difficult for the selected provider to receive an opportunity, since it may be communicated by the referrer using a variety of channels, some of which have high latency, or are used too infrequently to justify attending to them diligently. Also, inventors have additionally recognized that the selected provider may receive information about the referral in a form poorly suited to begin acting on, such as on paper, or a message that has to be pasted into a web form, or decomposed into individual pieces of data that are entered separately into a web form, such as property address, desired property attributes, referrer name and contact information, customer name and contact information, etc.

The above observations have led the inventors to recognize that both the referrers that convey opportunities to serve customers and providers that receive such opportunities would benefit from an automated system that performed such referrals using a standardized electronic mechanism, that permits each referrer the opportunity to define rules used to select one or more providers to receive each of the referral's opportunities.

In response to this recognition, the inventors have conceived and reduced to practice a software and/or hardware facility for automatically selecting providers to whom to direct referrals using selection rules specified by the referrer (“the facility”). In some embodiments, the selection is with respect to an organizational hierarchy of providers, such as one in which many each provider is the child of another provider; the child provider is sometimes described as being “below” its parent provider, while the parent provider is sometimes described as being “above” its child provider(s). In some embodiments, many or all providers are organized into a group of providers, such as revenue share groups; these may be the child of another group and the parent of one or more other groups.

In some embodiments, the facility provides a set of predefined selection rules from which the referrer can choose. Some of these predefined selection rules can relate to the organization of providers, such as providers in the same group as the referrer, providers who are the parent or other ancestor of the referrer, or providers who are the child or other descendant of the referrer. In some cases, these predefined rules seek to maximize revenue that may result from the referral for one or more parties, such as the referrer, an organization with whom the referrer is affiliated, and/or the operator of the facility.

In some embodiments, the referrer uses a user interface provided by the facility to define their own rule. For example, in some embodiments, the referrer types a case statement that specifies referrers to whom to direct the opportunity, based on one or more logical tests about its details. In some embodiments, the facility's user interface provides specialized user interface controls for constructing such a case statement. In some embodiments, the user types a narrative description of how this case statement should work, and the facility uses a large language model to transform this narrative into a corresponding rule. In some embodiments, such referrer-defined rules are stored by the facility to facilitate their reuse by the referrer for future opportunities, and/or other by referrers with whom the defining referrer has shared them.

In some embodiments, the facility supports having rules selected or defined on a referrer's behalf, such as by the referrer's supervisor or organization, either in place of referrer-selected or -defined rules, or to supplement these.

In various embodiments, the facility enables the referrer to select or define rules that relate to qualifications of providers, such as geographic location or licensure level; language skills; specialization in particular property types; marketing or affinity considerations, such as experience with or specialization in certain groups of consumers, such as active military or veterans, healthcare workers, small business owners, consumers from a particular culture or geographic origin. These can include both formal certifications, and self-selected designations. In some embodiments, the facility allows the referrer to specify a list of providers the referrer prefers as part of a rule they select or define. In various embodiments, the facility enables the referrer to select or define rules that relate to various aspects of how providers perform, such as response time to past referrals, or contacts directly by a consumer; the outcome for earlier referrals or other past projects, e.g., closing percentage, time to close, commission size, etc.; scores, ratings, or reviews generated for each provider by their peers, supervisor, and/or consumers.

In some embodiments, the facility uses the rule or rules selected or defined by the referrer to identify a group of candidate providers, in some cases in a particular preference order. In various embodiments, the facility uses various approaches to contacting the providers on the list. In some embodiments, the facility tries contacting the providers one at a time, and only advances to the next provider on the list if the current provider declines the referral, or times out. In some embodiments, the facility tries contacting the providers in parallel, ultimately selecting the provider that responds first, or a provide who responds with the highest referral fee or percentage bid among those received during a response time window.

In some embodiments, the facility contacts candidate providers about a referral by sending a message to a point of contact configured by the candidate provider, such as variously an email address, SMS number, synthetic speech voice call, message in a professional CRM or workflow system, slack address, etc., or in a specialized inbox provided to the candidate provider by the facility. In various embodiments, the facility includes a variety of information about the referral in this contact message. In some embodiments, the facility includes in this contact message a control that the candidate provider can use to accept the referral. In some embodiments, accepting the referral causes information about the referral—including in some cases information about the referral that was in the contact message and information that was not—to be populated into a directly-actionable tracking list maintained by the facility for the accepting provider. In some embodiments, in response to the acceptance, the facility invokes automatic follow-up behavior configured by the accepting provider, such as sending an email or SMS message to the consumer on the accepting provider's behalf that introduces the accepting provider and provides contact information and/or an automatic appointment scheduling mechanism.

In some embodiments, the facility supports having rules selected or defined on a referrer's behalf, such as by the referrer's supervisor or organization, either in place of referrer-selected or -defined rules, or to supplement these.

By operating in some or all of the ways described above, the facility streamlines the process of directing, accepting, and acting on referrals.

Additionally, the facility improves the functioning of computer or other hardware, such as by reducing the dynamic display area, processing, storage, and/or data transmission resources needed to perform a certain task, thereby enabling the task to be permitted by less capable, capacious, and/or expensive hardware devices, and/or be performed with lesser latency, and/or preserving more of the conserved resources for use in performing other tasks. For example, by automating the sending of referral contact messages, the facility saves processing resources and display real estate that would otherwise be committed to operating the user interface used by the referrer to manually send these messages. By automating the process of adding information about the referral to an7ctionnable list usable by the accepting provider, the facility similarly conserves processing resources and display real estate that would be committed to operating the user interface used by the accepting provider to manually update a status resource with this information.

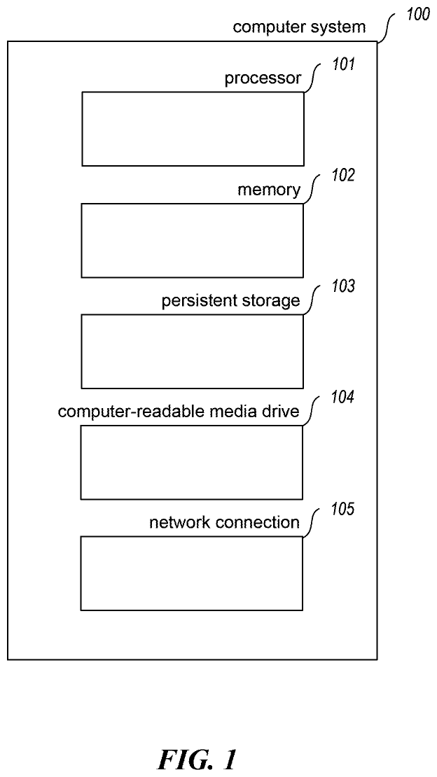

FIG. 1 is a block diagram showing some of the components typically incorporated in at least some of the computer systems and other devices on which the facility operates. In various embodiments, these computer systems and other devices 100 can include server computer systems, cloud computing platforms or virtual machines in other configurations, desktop computer systems, laptop computer systems, netbooks, mobile phones, personal digital assistants, televisions, cameras, automobile computers, electronic media players, etc. In various embodiments, the computer systems and devices include zero or more of each of the following: a processor 101 for executing computer programs and/or training or applying machine learning models, such as a CPU, GPU, TPU, NNP, FPGA, or ASIC; a computer memory 102 for storing programs and data while they are being used, including the facility and associated data, an operating system including a kernel, and device drivers; a persistent storage device 103, such as a hard drive or flash drive for persistently storing programs and data; a computer-readable media drive 104, such as a floppy, CD-ROM, or DVD drive, for reading programs and data stored on a computer-readable medium; and a network connection 105 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. While computer systems configured as described above are typically used to support the operation of the facility, those skilled in the art will appreciate that the facility may be implemented using devices of various types and configurations, and having various components.

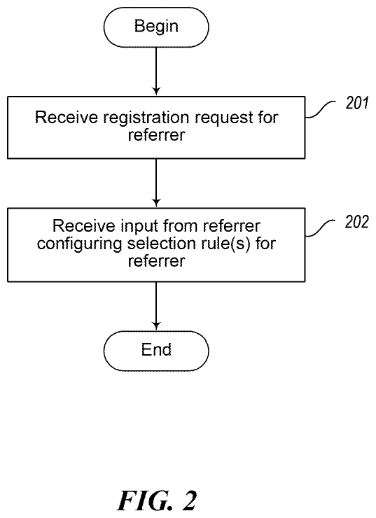

FIG. 2 is a flow diagram showing a process performed by the facility in some embodiments in order register a referrer. In act 201, the facility receives a registration request that identifies the referrer. In act 202, the facility receives input from the referrer configuring one or more selection rules for use in selecting providers to offer opportunities from the referrer. The stores this input for later use in directing the referral of future opportunities from the referrer to providers. After act 202, this process concludes.

Those skilled in the art will appreciate that the acts shown in FIG. 2 and in each of the flow diagrams discussed below may be altered in a variety of ways. For example, the order of the acts may be rearranged; some acts may be performed in parallel; shown acts may be omitted, or other acts may be included; a shown act may be divided into subacts, or multiple shown acts may be combined into a single act, etc.

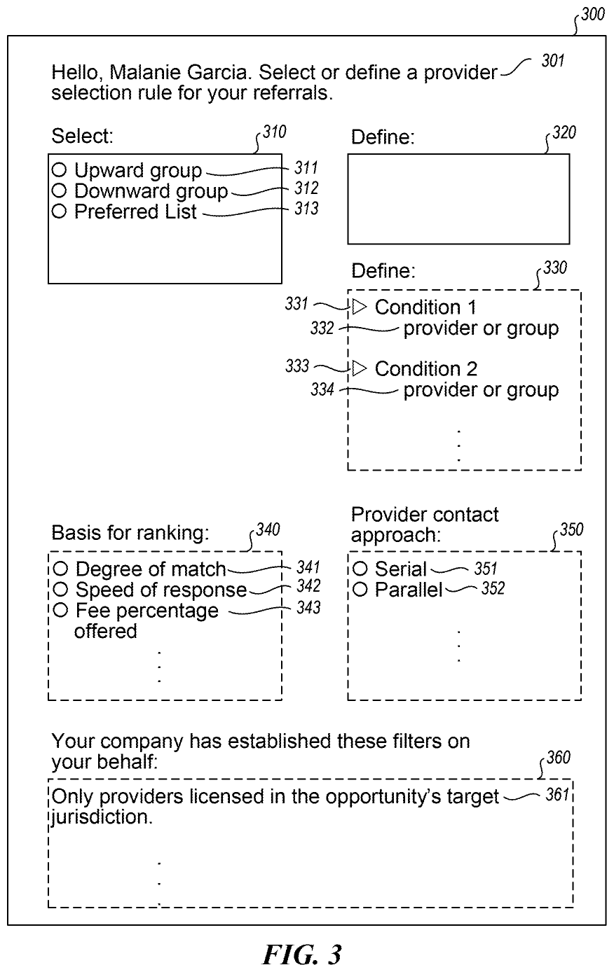

FIG. 3 is a display diagram showing a sample display presented by the facility in some embodiments to receive input from a referrer configuring selection rules for the referrer. The display 300 includes text 301 identifying the referrer and directing them populate the form included in the display to collect input for configuring selection rules on the referrer's behalf. The facility permits the user to select one of a number of predefined rules 310. In various embodiments, the facility permits these rules to be defined by the developer of the facility, the operator of the facility, an administrator of the facility on behalf of a group of users, or certain users of the facility. For example, as shown, these predefined rules include an upward group rule 311 for selecting one or more providers above the referrer in a provider hierarchy; a downward group rule 312 for selecting one or more providers below the referrer in the provider hierarchy; and a preferred list rule 313 that specifies selection of providers from a preferred list of providers separately defined by the referrer, such as one that can be updated as needed over time. In some embodiments, a group can include a single provider. The facility also permits the referrer to enter their own provider selection rule into in textual form field 320, such as one that uses explicit Boolean logic, grouping symbols, and evaluation symbols to select certain providers or groups of providers based upon on certain conditions. As shown, the facility also provides a specialized user interface 330 that the referrer can use to define a rule. In this user interface as shown, the facility can specify a condition using a condition control such as condition control 331, and a provider or group that is to be selected if that condition is true, such as provider or group 332.

The display also includes a control 340 for selecting a basis for ranking the providers selected by the selection rule selected or defined by the referrer, which is used as a basis for establishing an order among these selected providers in which the referral is offered to the selected providers. For example, control 340 includes options such as a degree of match 341 between the provider and conditions in the selection rule; a speed of response 342 of the provider to communications sent to the provider on behalf of the referrer offering the referral; and a fee percentage offered 343 by each provider in response to receiving a referral invitation.

The display also includes a control 350 for selecting an approach to be used in soliciting selected providers for the referral, such as a serial approach 351 in which the referral is offered to providers one at a time, and a parallel approach 352 in which the referral opportunity is offered to multiple selected providers at once.

The display also includes an indication 360 of one or more filters or other rules that have been specified on the referrer's behalf, such as by the referrer's employer or supervisor, that will be applied to referrals from the provider by the facility. Here, indication 360 shows that a filter has been established on the referrer's behalf to eliminate from consideration any providers not licensed in a target jurisdiction associated with the opportunity, such as a geographic or administrative region or zone in which a real estate buyer seeks to purchase a property.

While FIG. 3 and each of the display diagrams discussed below show a display whose formatting, organization, informational density, etc., is best suited to certain types of display devices, those skilled in the art will appreciate that actual displays presented by the facility may differ from those shown, in that they may be optimized for particular other display devices, or have shown visual elements omitted, visual elements not shown included, visual elements reorganized, reformatted, revisualized, or shown at different levels of magnification, etc.

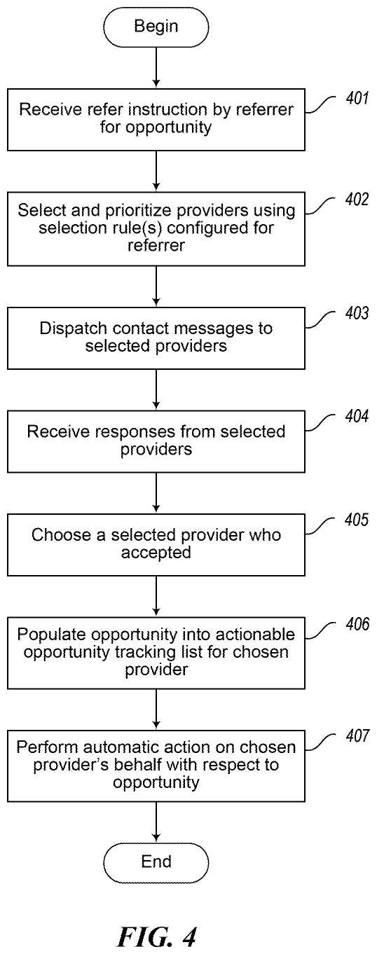

FIG. 4 is a flow diagram showing a process performed by the facility in some embodiments to perform a referral for a particular opportunity. In act 401, the facility receives a refer instruction by a referrer for an opportunity. In some embodiments, this involves the referrer giving an explicit instruction for this particular opportunity. In some embodiments, the referrer gives a standing instruction that certain types of opportunities that flow to the referrer are to be automatically referred by the facility, such as opportunities that are to assist a property buyer in a jurisdiction in which the referrer is not licensed, or the referrer chooses not to operate. In various embodiments, these opportunities are received in a variety of ways, including consumers responding to marketing messages directed to them by or on behalf of the referrer; consumers responding to advertisements placed by or on behalf of the referrer; consumers acting on a published professional profile of the referrer; consumer interactions with shopping tools or property or product exploration tools provided by or on behalf of the referrer; etc.

In some embodiments, these messages are sent by the facility instead of or in parallel with messages sent by the referrer. As an example, the referrer shares an initial link that a potential buyer visits. The potential buyer signs up on that visit or on a return visit. Three months later, the facility sends a message about 1) a new home being listed or 2) a real estate guide article with information useful to the potential buyer. After one of those messages, the potential buyers interacts and is marked by the facility as ready to be referred.

In act 402, the facility selects and prioritizes providers to whom to offer the opportunity using selection rules configured by the referrers, such as described above in connection with act 202 shown in FIG. 2, and such as by a user interface like the one included in the display 300 shown in FIG. 3. In act 403, the facility dispatches contact messages to some or all of the providers selected in act 402 that offer them the referral. In some embodiments, this dispatch is in accordance with an approach configured by or on behalf of the referral, such as serial and parallel approaches. In various embodiments, the facility dispatches the contact messages using various communication channels, such as email messages, SMS messages, voicemails, messages in a professional CRM or workflow system, Slack messages, etc.

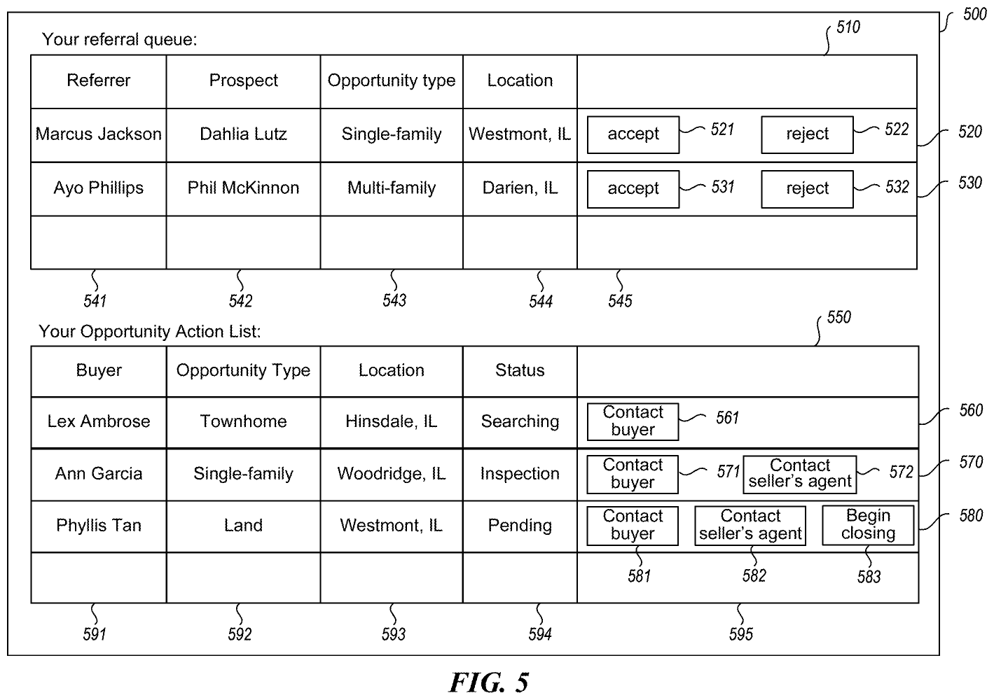

FIG. 5 is display diagram showing a sample display presented by the facility in some embodiments to a provider who is eligible to receive referrals directed in accordance with the facility. The display 500 includes a referral queue 510 containing a set of referrals that have been offered to this provider. In particular, the referral queue shows two offered referrals 520 and 530. For each referral, the referral includes information 541 identifying the referrer; information 542 identifying the prospect; information 543 identifying the type of opportunity for which referral is being offered; information 544 identifying a location associated with the opportunity; and controls 545. For example, for opportunity 520, the referral queue identifies Marcus Jackson as the referrer, Dahlia Lutz as the prospect, and the opportunity being to find and purchase a single-family residential property in Westmont, IL. The provider could operate accept control 521 in order to accept offered referral 520, or operate reject control 522 in order to reject this opportunity, in response to either of which the facility removes the opportunity from the referral queue. In some embodiments, the provider can click on one of the offered referrals in order to display additional information about the referral, such as additional information included in the referrer's contact message, and/or additional information retrieved from a separate database or other information resource that maintains information about opportunities, prospects, etc.

In some embodiments (not shown), the facility redacts this information identifying the prospect until the receiving agent accepts the referral. There are many stories of sharing prospect information with a receiving agent and 1) never getting a signed referral agreement and 2) the receiving agent then either working the lead or then referring it out themselves. In some embodiments, the facility therefore protects the client/prospect information until a referral agreement is signed by both the sending and receiving agent. In some embodiments, all terms are agreed to by using the facility and buyers/sellers are tracked in a way where the disclosing of prospect information does not raise a concern to the referral agent being compensated. In some embodiments, the referring agent vets the potential providers prior to disclosing the prospect's information.

Returning to FIG. 4, in act 404, the facility receives responses from one or more of the selected providers to whom contact messages were dispatched in act 403. These can include any combination of responses sent by clicking controls like controls 521 and 522 shown in FIG. 5, and responses to contact messages of different types, such as email messages, SMS messages, voicemails, messages in a professional CRM or workflow system, Slack messages, etc.

In act 405, the facility chooses, among the selected providers from whom acceptance messages were received in act 404, a particular provider to whom to confer the referral. In 406, the facility populates the opportunity into an actionable opportunity tracking list for the provider chosen in act 405. In 407, the facility performs one or more automatic actions on behalf of the chosen provider with respect to the opportunity, such as sending an initial contact message to the prospect. Seeking administrative assistance with the opportunity from a designated staff member, scheduling an appointment to speak live with the prospect, etc. After 407, this process concludes.

Returning to FIG. 5, the display also shows an opportunity action list 550 generated and maintained by the facility for the provider. Three opportunities are shown in this opportunity action list, opportunities 560, 570, and 580. For each opportunity, the opportunity action list includes information 591 identifying a buyer associated with the opportunity; information 592 specifying a type of the opportunity; information 593 specifying a location with which the opportunity is associated; information 594 specifying a present status of the opportunity; and controls 595 that the provider can activate in order to take action with respect to the opportunity, either to change the status or other information about the opportunity in the opportunity action list or the underlying data, or to take external action such as contacting particular people, initiating automatic workflow actions, etc. For example, for opportunity 570, the opportunity action list indicates that the buyer is Ann Garcia, the opportunity is a single-family residence purchase opportunity, located in Woodridge, IL, and the opportunity is in an inspection stage. For this opportunity, the provider can activate control 571 in order to initiate a new contact with the buyer—such as an email, SMS message, or voice call; or activate control 572 in order to similarly contact a seller's agent for a property that has been identified for this opportunity. In some embodiments, the facility further provides a control for contacting the referring agent, who may have valuable information regarding the prospect even after the referral is made that could benefit any or all parties involved.

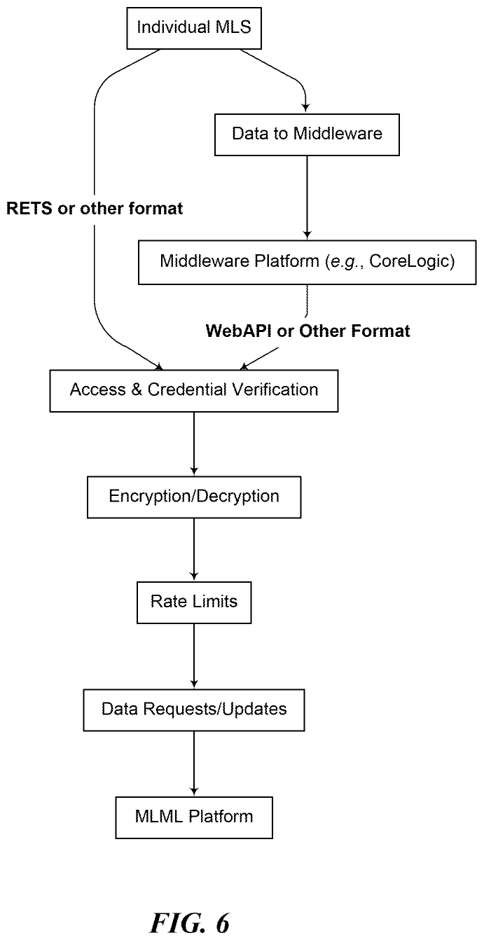

In some embodiments, the facility uses or accesses one or more of: a multiple listing system (MLS); a MLS data ingestion system; a MLS data normalization system; a MLS compliance engine (MCE); a consumer home search platform; a curation engine; a content sharing system; a referral agreement system; and a real estate transaction tracking system. Each of the above-described platforms, systems, engines, etc. are described below in further detail in reference to FIGS. 6-18.

FIG. 6 is a block diagram showing a sample data ingestion system for a multiple listing system, used by the facility in some embodiments. The facility uses the data ingestion system to access data from one or more data sources, such as one or more MLSs. In some embodiments, the data included in an MLS includes listing data associated with one or more real estate listings.

In some embodiments, the facility accesses the data from the MLS via one or more “middleware platforms,” such as, for example, CoreLogic, Bridge Interactive, Trestle, or other middleware platforms for MLS data. In some embodiments, the data accessed by the facility is: received by a middleware platform from the MLS; is subjected to one or more access or credential verifications; is subjected to encryption, decryption, or some combination thereof; is subjected to one or more rate limits; or is subjected to other manipulations, adjustments, analysis, etc., of the data. In some embodiments, the facility requests the data. In some embodiments, the facility causes the data to be updated, such as by transmitting an indication of an update to one or more MLSs.

In some embodiments, the facility accesses data included in a middleware platform via an application programming interface (API). In some embodiments, the facility receives the data without the data being transmitted to a middleware platform. In such embodiments, the facility may access the data via a Real Estate Transaction Standard format.

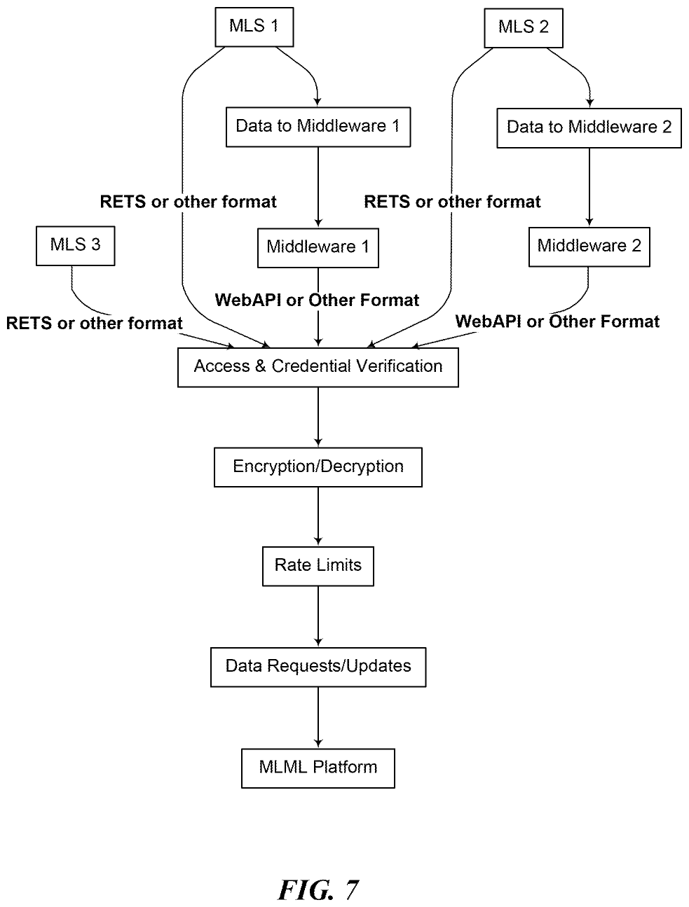

FIG. 7 is a block diagram showing a sample data ingestion system that accesses data from multiple MLSs, used by the facility in some embodiments. As depicted in FIG. 7, a data ingestion system used by the facility may be used to access a plurality of MLSs, data sources, etc. The facility may access data directly from some MLSs and may access data from other MLSs via middleware. As described above in connection with FIG. 6, the facility may access data from an MLS via the RETS format, one or more APIs, or other formats useful for accessing data included in an MLS.

Although FIGS. 6 and 7 depict data from an MLS being subjected to additional adjustments, manipulations, analysis, etc., embodiments are not so limited, and the data may be subjected to none of, a portion of, etc., the adjustments, manipulations, analysis, etc., depicted in FIGS. 6 and 7.

In some embodiments, the facility uses the functions, services, processes, etc., (collectively “functions”) depicted in FIGS. 6 and 7 to ingest, process, and otherwise make available the data included in the MLSs to other functions, services, data stores, etc., associated with or used by the facility. In such embodiments, the facility ensures one or more of: data integrity; data security; data usability; etc., of the data included in the MLS. Furthermore, in some embodiments, at least a portion of the functions described in connection with FIGS. 6 and 7 are performed by a data ingestion system of the facility. Additionally, the facility may perform these functions with respect to one or more MLSs, one or more middleware platforms associated with one or more MLSs, or some combination thereof.

In some embodiments, in performing the access and credential verification function depicted in FIGS. 6 and 7, the facility ensures that the data is legitimate, access to the data is authorized, etc.

In some embodiments, in performing the encryption/decryption function depicted in FIGS. 6 and 7, the facility encrypts or decrypts data transmitted from an MLS or transmitted to the facility.

In some embodiments, in performing the rate limit function depicted in FIGS. 6 and 7, the facility accounts for one or more rate limits of one or more MLSs or other systems used to access data included in MLSs. A rate limit imposed by a MLS indicates at least one of a threshold amount of data that can be accessed at one time and a threshold frequency for accessing data. In such embodiments, the facility may identify the rate limits imposed by one or more MLSs and account for them when accessing the MLS data. In some embodiments, accounting for the rate limits includes one or more of: ensuring continuous data flow and providing accurate data to the facility or aspects of the facility.

In some embodiments, in performing the data request and update function depicted in FIGS. 6 and 7, the facility sends one or more requests to an MLS for data. In some embodiments, in performing the data request and update function depicted in FIGS. 6 and 7, the facility receives data from an MLS. In some such embodiments, the MLS pushes data to the facility before the facility requests the data.

In some embodiments, where one or more middleware platforms are used by one or more MLSs, the facility uses one or more additional functions to account for modifications, analysis, processing, etc., to which a middleware platform may subject data included in an MLS.

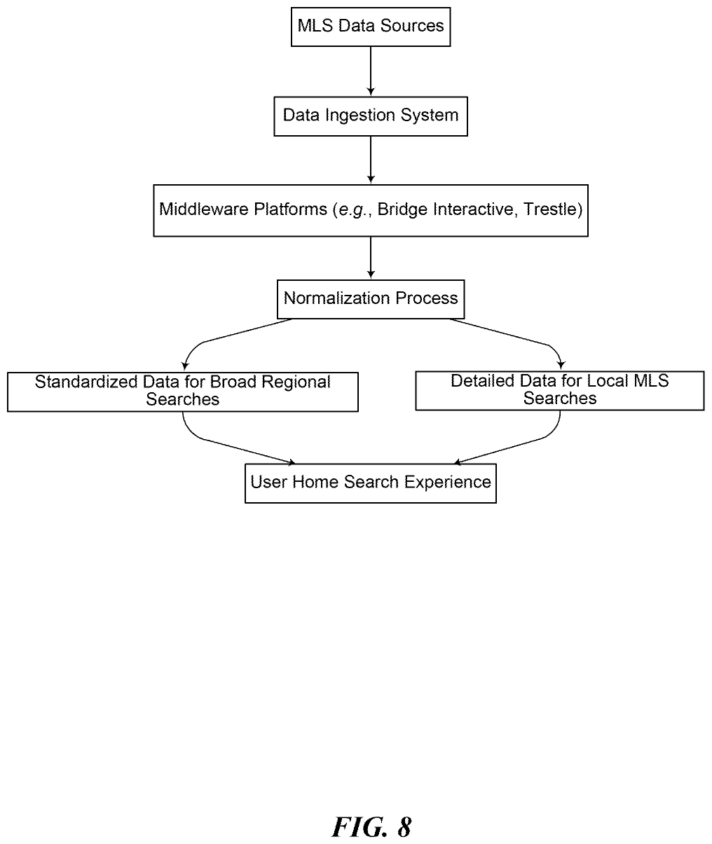

FIG. 8 is a sample data flow diagram of MLS data showing the flow of MLS data in some embodiments. The data flow depicted in FIG. 8 depicts an example flow of data from MLS sources and through one or more of: a data ingestion system, one or more middleware platforms, and a normalization process. In this example data flow, the normalization process outputs standardized data for regional searches and detailed data MLS searches. The facility may present the standardized data and detailed data to a user.

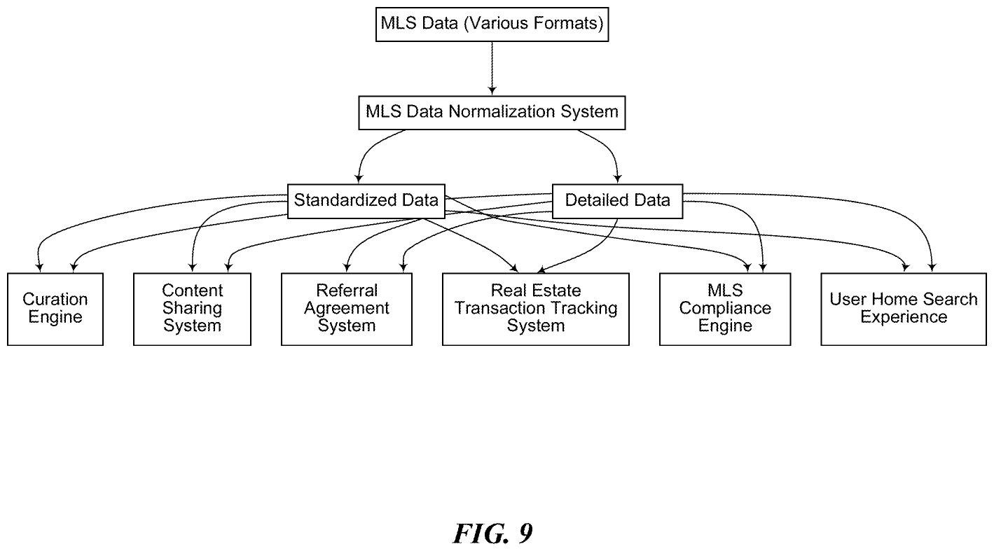

FIG. 9 is a sample block diagram showing a MLS data normalization system (a “normalization system”), used by the facility in some embodiments. The normalization system receives MLS data and extracts standardized data, detailed data, or some combination thereof from the MLS data. In some embodiments, at least a portion of the MLS data is in one or more different forms or formats. In some embodiments, at least one of the standardized data and detailed data is used by the facility for one or more processes, systems, operations, functions, etc., such as: a curation engine, a content sharing system, a referral agreement system, a real estate transaction tracking system, a MLS compliance engine, and a user home search system.

In some embodiments, the data included in one MLS system may have one or more structures, formats, terminologies, etc., that are different than data included in another MLS system. In such embodiments, the differences in data included in MLS systems may be based on one or more of: regional preferences, historical practices, the interpretation of standards set by one or more entities such as the Real Estate Standards Organization, etc. In some embodiments, the facility uses the normalization system to normalize the data based on identified differences between MLS systems. In some embodiments, the facility uses the normalization system to format data received from one or more MLS systems into one or more standard formats. In such embodiments, by normalizing the data, the facility may improve the ability of computing devices to use and store the data, such as by reducing the need to preprocess data before it is used. Furthermore, in such embodiments, one or more user interfaces presented by the facility are able to be made more efficient and consistent by generating the user interfaces based on normalized data.

In some embodiments, the facility uses normalization system to normalize varied types of data received from MLSs, such as: status identifier, property types, addresses, and any other data that may be included in an MLS. For example, different MLSs may each have one or more different status identifiers that convey similar stages of a property listing. In this example, the data normalization system consolidates the different status identifiers into a standardized set of status identifiers. In an illustrative example, a particular MLS may use the status identifier “Pending Continue to Show Inspection” while another may use the status identifier “Contingent Due Diligence.” The data normalization system changes the status identifiers for each to “Active Under Contract,” based on the status indicated by the status identifiers from each MLS. In another example, property type identifiers may be changed based on one or more categories of the property. In a further example, property addresses may be normalized into a standard address format from other disparate address formats.

In some embodiments, the normalization system detects new formats, terminologies, etc., of data used by MLSs, other data sources, or some combination thereof. In some embodiments, the normalization system uses artificial intelligence or machine learning models configured to identify new formats, terminologies, etc., included in MLS data. In some embodiments, the normalization system detects the new formats, terminologies, etc., based on at least user input.

In some embodiments, the normalization system normalizes data from other data sources into a format consistent with data received from an MLS. For example, the normalization system may normalize one or more of: location data, footprint data, traffic pattern data, weather data, crime statistic data, sales tax data, property tax data, and other types of data.

In some embodiments, the facility retains an indication of non-normalized forms of the data that is normalized by the normalization system. In such embodiments, the facility uses the non-normalized data to improve searches within a selected geographic region. In such embodiments, the facility is able to perform searches based on the normalized data, searches based on the non-normalized data, or some combination thereof. For example, a user may use the facility to perform a broad search on the normalized data for a geographic region, and in response to an indication that the search should be refined, the facility further refines the search to provide additional detail to the user based on the non-normalized data.

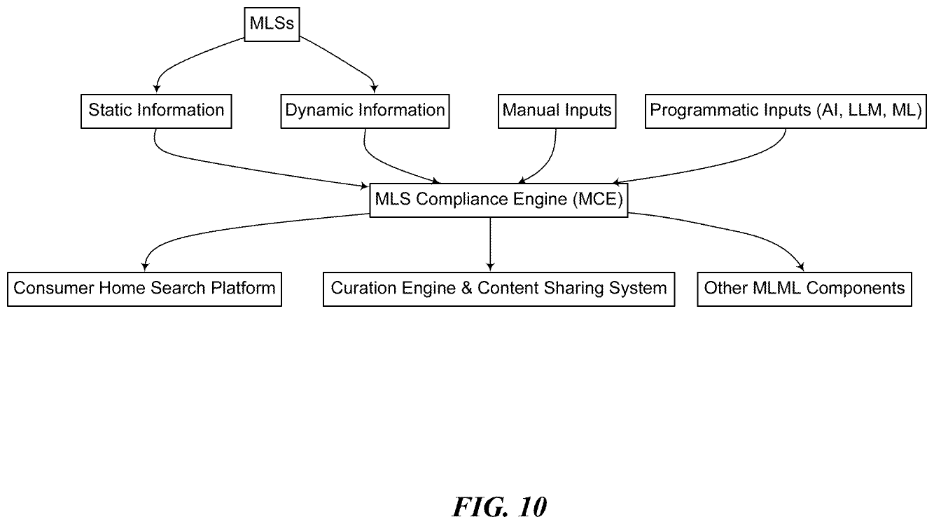

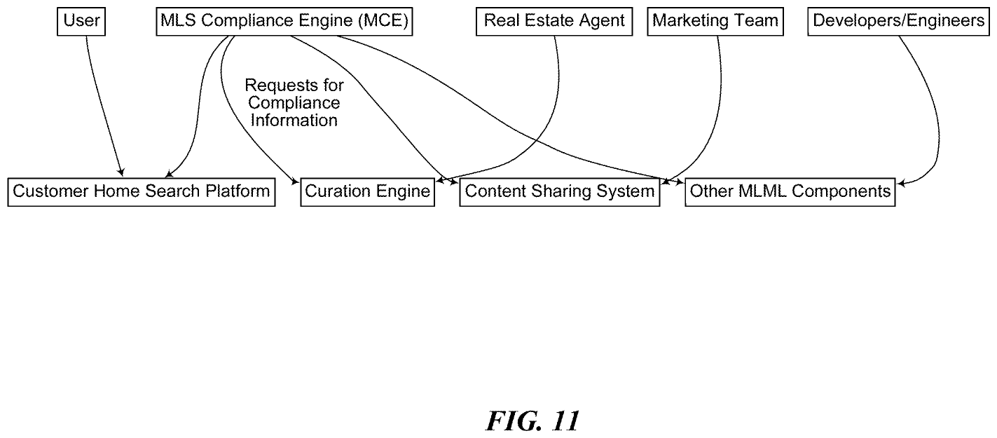

FIG. 10 is a sample data flow diagram showing the flow of data used by a MLS compliance engine (“MCE”) in some embodiments. FIG. 11 is a sample block diagram showing one or more entities, systems, processes, functions, etc., that may access an MCE in some embodiments.

In some embodiments, the facility uses the MCE to ensure that one or more MLSs, the data received therefrom, other data sources, etc., are compliant with one or more rules, such as licensing requirements, laws, etc. In some embodiments, one or more MLSs have, or are subject to, different rules for which the MCE uses to ensure that the data received from the MLSs are compliant.

In some embodiments, the MCE processes at least one of: static data and dynamic data from an MLS. In some embodiments, static data includes one or more of: an identifier for the MLS, a local time zone of the MLS, a logo of the MLS, and other attributes of an MLS that change infrequently. In some embodiments, dynamic data includes data that may change based on one or more listings, during the marketing of a listing, etc., such as a display price per square foot, listing agent details, and other data included in an MLS that may change.

In some embodiments, the MCE communicates with multiple MLSs, such as directly or through one or more middleware platforms. The MCE receives an indication of compliance rules for an MLS and compares data received from the MLS to the compliance rules to determine whether the MLS, its data, etc., is compliant with the compliance rules. In some embodiments, the MCE receives the compliance rules via user input, artificial intelligence models, machine learning models, large language models, or other systems or methods of obtaining compliance rules from an MLS.

In some embodiments, the MCE integrates the compliance rules into one or more listings presented to a user that are associated with an MLS. In some embodiments, where an interface includes listings from a plurality of MLSs, the MCE integrates the compliance rules into the respective listings based on the MLS associated with the respective listing.

In some embodiments, the MCE detects and resolves discrepancies and anomalies included in the compliance rules. The MCE may resolve the discrepancies and anomalies via one or more of: input from a user, such as a user associated with an MLS, a user associated with the facility, etc.; and one or more machine learning or artificial intelligence models trained to detect, resolve, propose a resolution to, etc., discrepancies and anomalies included in compliance rules.

In some embodiments, the MCE ensures that shared content associated with a listing follows the compliance rules, such as, for example, content posted on social media, content printed onto paper flyers, etc. In some embodiments, the MCE ensures that one or more disclosures indicated by an MLS are made when the content is shared, such as one or more disclosures determined to be necessary based on compliance rules.

In some embodiments, the facility uses the MCE to integrate and represent data received from multiple MLSs and other data sources in various content forms, content platforms, etc.

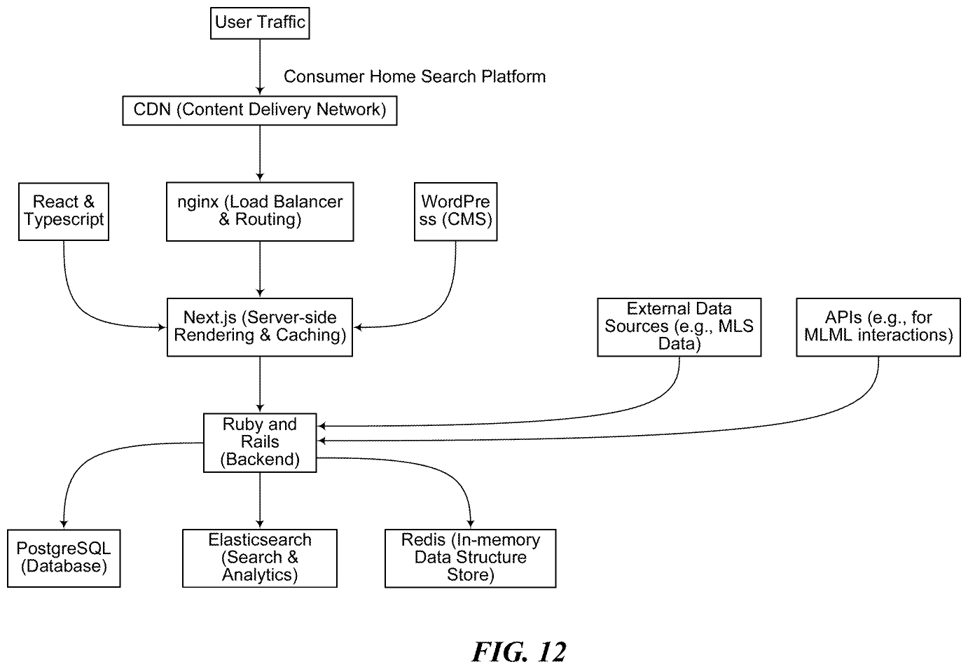

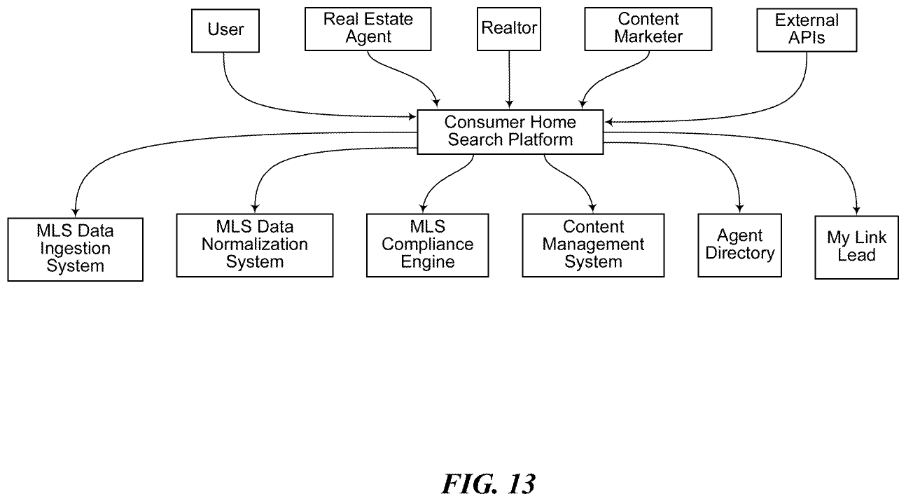

FIG. 12 is a sample block diagram showing a consumer home search platform (“search platform”), used by the facility in some embodiments. FIG. 13 is a sample block diagram showing the interaction of the search platform with one or more other functions, services, systems, etc., of the facility in some embodiments.

In some embodiments, the facility uses the search platform to provide an interface for users to perform searches, create content regarding listings, and perform other tasks related to searching for, creating, or sharing listings. In such embodiments, the facility performs the searches by using data received from one or more MLSs. The facility receives and prepares data from one or more MLSs via one or more of: a data ingestion system, such as the data ingestion system described above in connection with FIGS. 6 and 7; a normalization system, such as the normalization system described above in connection with FIGS. 8 and 9; and an MCE, such as the MCE described above in connection with FIGS. 10 and 11.

In some embodiments, one or more aspects of the search platform are implemented by using one or more tools or languages, such as: Ruby on Rails, React, Typescript, JavaScript, Redis, PostgreSQL, Elasticsearch, and WordPress. In such embodiments, the tools or languages may be used to provide or generate user interfaces, searching functionality, or other functions of the search platform.

In some embodiments, the search platform uses one or more artificial intelligence or machine learning models to create content, such as by: generating one or more content outlines, predicting one or more questions that a user may ask in response to content, determining the complexity of written content, optimizing content for search engines, or other methods of generating, evaluating, or adjusting content.

In some embodiments, the facility uses the search platform in conjunction with a normalization system to provide standardized data that is searched, standardized filtering options, or other standardizations or normalizations of aspects of the search platform. In some embodiments, the search platform includes a “chatbot,” such as an artificial intelligence chatbot, that automatically transmits messages to one or more users via the search platform. In such embodiments, the chatbot may use one or more responses provided by the users to perform one or more searches via the search platform.

In some embodiments, the search platform is deployed with one or more of: load balancers, content delivery networks (CDNs), caching techniques, or other systems or methods used to provide a scalable search platform to users, search engines, or other entities.

In some embodiments, the facility integrates one or more aspects of the search platform into one or more other systems, functions, processes, etc., used by the facility. For example, the facility may integrate aspects of the search platform into one or more individual agent profiles included in an agent directory to generate localized listing summaries. In another aspect, the search platform may be used to display listings based on selected criteria.

In some embodiments, the search platform is separate from one or more other aspects of the facility. In such embodiments, the search platform uses one or more APIs to communicate with one or more aspects of the facility.

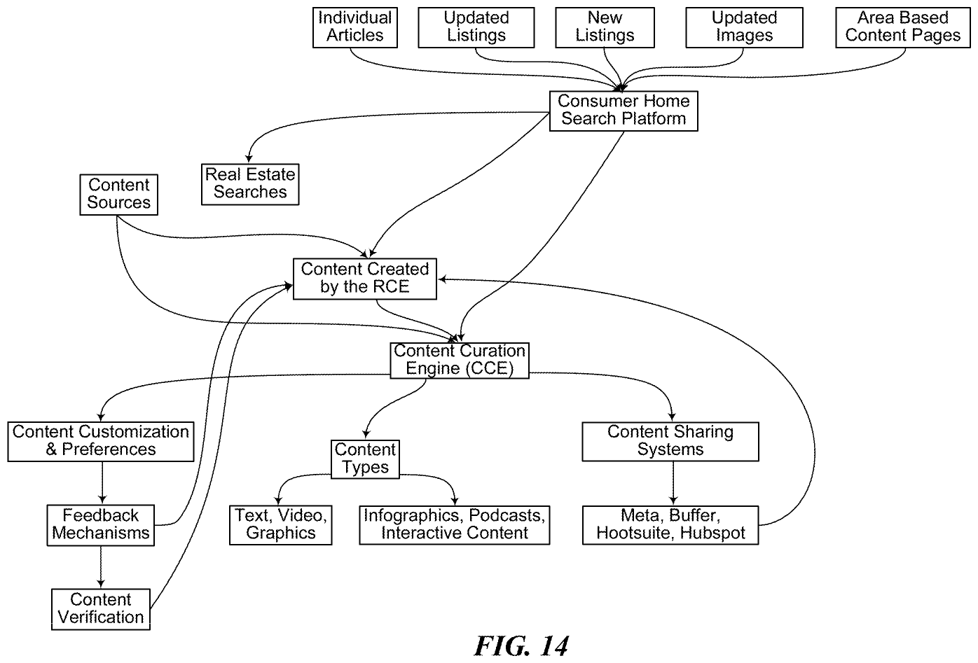

FIG. 14 is a sample data flow diagram showing the flow of data between a content curation engine (“CCE”) and other aspects of the facility in some embodiments. The content creation engine includes, performs, or otherwise uses one or more of: one or more content sources; one or more content customizations; one or more content preferences; one or more feedback functions; one or more content verification functions; one or more content types; one or more content sharing systems; or one or more search platforms.

In some embodiments, a content source includes data and content transmitted to the CCE, such as content or data used by one or more other aspects of the facility. In some embodiments, the one or more content customizations or more content preferences include data used by the CCE to adapt data or content. In some embodiments, the CCE or other aspects of the facility receive one or more content customizations, one or more content preferences, etc., via one or more of: input, such as user input, input from one or more aspects of the facility, etc.; one or more algorithms, processes, methods, etc., for determining, generating, identifying, etc., one or more content customizations, one or more content preferences, or some combination thereof; or some combination thereof.

In some embodiments, the one or more feedback systems include one or more systems that receive data indicating feedback for curated content from one or more users. In some embodiments, the one or more feedback systems prompt one or more users for the data indicating the feedback.

In some embodiments, the content verification systems include one or more methods, processes, algorithms, etc., for verifying accuracy, authenticity, etc., of curated content. In some embodiments, the one or more content types include one or more content formats that the CCE is able to curate or suggest. In some embodiments, the content sharing systems include one or more platforms, tools, etc., for disseminating content to one or more computing devices, one or more content repositories, or one or more other systems to which content can be transmitted.

In some embodiments, the search platform used by the CCE is similar to the search platform described above with respect to FIGS. 12 and 13. In some embodiments, the CCE receives one or more of: updated listings, new listings, images, area based content pages, articles, real estate searches, or other data from the search platform.

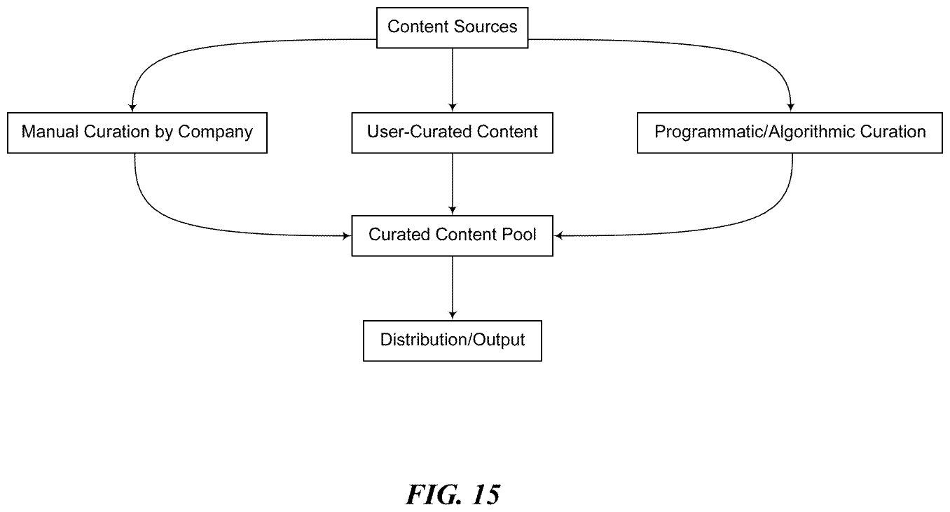

FIG. 15 is a sample data flow diagram showing the flow of curated content data accessed by the CCE in some embodiments. The curated content data includes data received from one or more of: content sources; content curated by an entity, such as a real estate company; content curated by a user; content curated by one or more programs, algorithms, etc., of the CCE; and content included in a curated content pool. In some embodiments, the CCE distributes or outputs curated content data to one or more channels, platforms, systems, repositories, or other systems in which content is shared or displayed. For example, systems in which content is shared may include one or more websites, newsletters, social media platforms or other systems for sharing content.

In some embodiments, a content source is a source from which content is received, such as a website, a database, a social media platform, user submissions, or other sources of content.

In some embodiments, content curated by an entity includes content selected, reviewed, or curated by one or more users associated with the entity. In some embodiments, the content curated by a user includes content selected, reviewed, or curated by one or more users of one or more aspects of the facility, such as via identifying bookmarked content, input from a user, or other methods of selecting, reviewing, or curating content from users. In some embodiments, the content curated by one or more algorithms or programs is content that is selected, reviewed, or curated by one or more programs or algorithms of the CCE, such as programs or algorithms that use, access, or identify one or more of: preselected criteria, user behavior, trends, or other factors associated with selecting, reviewing, or curating content. In some embodiments, the selection, review, or curation includes evaluating the relevance or quality of the content.

In some embodiments, the curated content pool includes curated content identified based on one or more of: content selected, curated, or reviewed by one or more entities; content selected, curated, or reviewed by one or more users; or content selected, curated, or reviewed by one or more programs or algorithms.

In some embodiments, the CCE used by the facility streamlines, enhances, or some combination thereof, one or more content marketing efforts of one or more users of the facility, such as by generating, selecting, curating, identifying, etc., content for the one or more users. In some embodiments, the CCE automates, identifies, creates, optimizes, personalizes, or some combination thereof, content dissemination.

In some embodiments, the CCE uses one or more data sources accessed by the facility to implement one or more feedback loops for curating content. In some embodiments, the CCE uses one or more data sources accessed by the facility to identify diverse content for one or more users of the facility, such as two or more instances of content that have different content types, are related to different types of listings, etc.

In some embodiments, the content pool is continuously updated. In such embodiments, the CCE may access one or more data sources of the search platform. In an example embodiment, the CCE accesses a plurality of active listings, updated listings, new listings, images, and updated images. In such an example embodiment, the CCE is able to obtain updates daily, hourly, weekly, every minute, etc. In an example embodiment, the CCE accesses greater than a million active listings, and receives approximately 130,000 updated listings, 25,000 new listings, and 5000,000 updated images daily.

In some embodiments, the CCE accesses one or more of: area based content pages; individual articles; real estate searches that include one or more of: one or more selected property types, one or more selected zip codes or other geographic areas, one or more properties identified as luxury properties, one or more properties proximate to major cities, etc. (for example, luxury cabins in a plurality of geographic areas, condos in one or more geographic areas, luxury cabins within a selected distance of one or more geographic areas, etc.); content created by the CCE that is identified via one or more aspects of the facility, such as properties with one or more selected features; or some combination thereof. For example, the CCE may access content based on a user selection of a style of kitchen, a view that can be seen from the property, etc.

In some embodiments, the CCE curates content for a selected user based on one or more preferences of the user. In some embodiments, the preferences may be received via a selection by the user, one or more programs or algorithms that determine the preferences, or some combination thereof. In some embodiments, at least one program or algorithm curates content based on at least historical data regarding past listings, content, etc., associated with the user. In some embodiments, at least one program or algorithm curates content based on at least one or more content engagement metrics associated with at least one instance of content. In an example embodiment, the CCE receives one or more selections of content for curation from a user and identifies other content for curation based on at least the one or more selections.

In some embodiments, the one or more feedback systems receive input from one or more users regarding curated content. In such embodiments, the CCE may use the input received from the one or more feedback systems to curate content for the user. In some embodiments, at least one of the feedback systems receives, obtains, etc., input from one or more platforms, such as, for example, Meta, Twitter, Gmail, Buffer, Hootsuite, Hubspot, or other platforms. In such embodiments, the CCE may generate one or more performance metrics of content. In some embodiments, the CCE uses one or more performance metrics of content to curate content.

In some embodiments, the CCE curates content of a plurality of content types, such as text content, video content, graphic content, infographic content, podcast content, interactive content, or other content. In some embodiments, the CCE receives the content from at least one of: user input, such as content collected, generated, etc., by one or more users and artificial intelligence or machine learning models configured to generate content. For example, the CCE may receive audio-visual content recorded by one or more users. In another example, the CCE may receive audio-visual content generated by an artificial intelligence or machine learning model, such as an artificial voiceover, generated video, etc.

In some embodiments, the CCE includes one or more functions or systems that asses the accuracy, authenticity, etc., of content. In some embodiments, the CCE uses programmatic, algorithmic, automatic, or some combination thereof, validation of the content. In some embodiments, the CCE presents content to one or more users for approval before the content is distributed or output by the CCE.

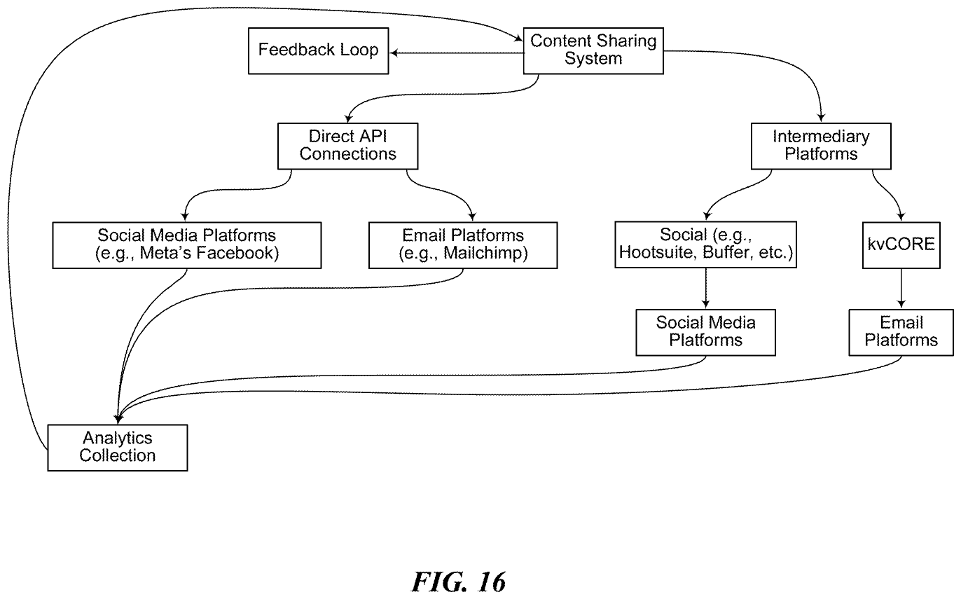

FIG. 16 is a sample data flow diagram showing the flow of data between a content sharing system (“CSS”), content platforms, and other aspects of the facility in some embodiments. The CSS transmits content to or receives content from: one or more platforms; as part of a feedback loop; from an analytics collection system associated with the facility; or some combination thereof. In some embodiments, the content is distributed according to the data flow diagram of FIG. 16 directly or indirectly through one or more intermediary platforms, aspects of the facility, or some combination thereof.

In some embodiments, the content sharing system distributes content across one or more marketing channels, one or more platforms, one or more aspects of the facility, etc. In some embodiments, the CSS is a conduit between content curated or created by the CCE and a one or more marketing channels, platforms, etc., selected by a user of the facility. In such embodiments, the CSS may include one or more user interfaces, software as a service dashboards, text messages, chatbots, or other interfaces. The interfaces provided by the CSS may be used by users of the facility to interact with content, such as viewing content, reviewing content, and accessing one or more performance metrics of the content.

In some embodiments, the CSS adapts content to one or more preferences of one or more users of the facility. In such embodiments, the preferences may be selected by one or more users, generated by one or more algorithms or processes for generating preferences, or some combination thereof. For example, the CSS may adapt content based on one or more: past transactions associated with one or more users, one or more content engagement metrics of content, etc.

In some embodiments, the CSS may prioritize content for a user. In such embodiments, the CSS may determine the prioritization of content based on one or more of: a first-in-first-out approach, a last-in-last-out approach, user input, analysis of data indicating audience preferences of a user, analysis of data indicating engagement with content, etc.

In some embodiments, the CSS uses one or more feedback loops to share content. In such embodiments, the feedback loops may include receiving input from one or more users regarding content shared to one or more platforms. In some embodiments, the CSS uses the feedback loops to determine one or more content performance metrics of the content. In such embodiments, the CSS may use the content performance metrics to identify one or more platforms for sharing the content.

In some embodiments, the CSS posts, or otherwise transmits to, one or more platforms or marketing channels via one or more APIs associated with the platforms or marketing channels. In some embodiments, the one or more platforms or marketing channels are selected based on input from a user of the facility.

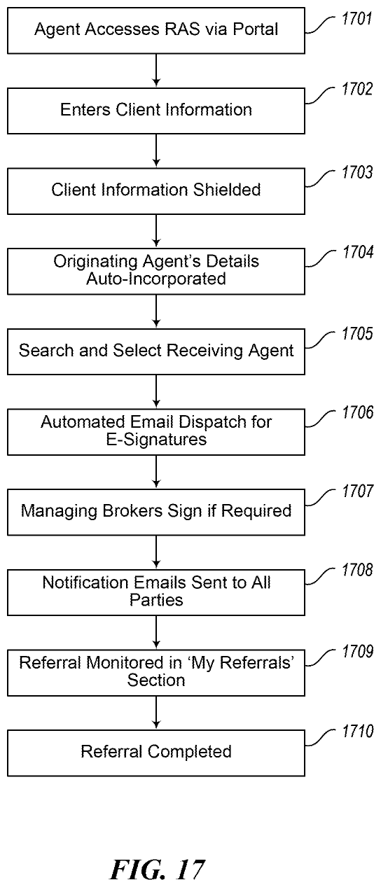

FIG. 17 is a flow diagram of a sample process to use a referral agreement system (“RAS”), used by the facility in some embodiments. The RAS includes one or more processes, systems, etc., that protect client information, automate the inclusion of information regarding a user of the facility, provide an e-signature process, and monitor referrals. In some embodiments, the processes and systems of the RAS standardize a referral process for one or more users of the facility. In some embodiments, the facility uses the RAS to optimize a referral process for one or more users of the facility. In some embodiments, the RAS includes a “universal” referral agreement that is used as a basis for referrals initiated by one or more users of the facility.

The process to use a referral agreement system begins at act 1701, where a user of the facility accesses the RAS via an interface, such as a portal, associated with the facility.

At act 1702, the RAS receives client data, such as a name, phone number, email, or other information related to a client. In some embodiments, the client data is input into a referral form.

At act 1703, the client data is hidden from a user receiving the referral until a threshold amount of the users associated with the referral have electronically signed the referral agreement.

At act 1704, data indicating the user originating the referral is automatically incorporated into the referral agreement. In some embodiments, the data indicating the user originating the referral includes one or more of: a name, an indication of a brokerage, a phone number, an email, or other data indicating a user that originates a referral.

At act 1705, the RAS searches for and selects at least one user to receive the referral. In some embodiments, the RAS uses an internal repository of users as part of performing act 1705. In some embodiments, the RAS receives input from as user to select the user that receives the referral.

In some embodiments, in response to the selection of at least one user to receive the referral, data indicating the user receiving the referral is automatically incorporated into the referral agreement. In some embodiments, the data indicating the user receiving the referral includes one or more of: a name, an indication of a brokerage, a phone number, an email, or other data indicating a user that originates a referral.

At act 1706, the RAS generates, and causes to be transmitted, one or more messages to one or more users associated with the referral. In some embodiments, the one or more messages may include one or more emails. In some embodiments, the emails are generated via an electronic signature system. In some embodiments, the messages include a prompt for the users associated with the referral to sign the referral agreement. In some embodiments, at act 1706, the RAS identifies one or more users associated with the referral agreement based on one or more of: a geographic location of a receiving user, one or more rules, regulations, etc., associated with referral agreements, or other factors for identifying a user associated with a referral agreement.

At act 1707, the RAS determines whether one or more brokers associated with the referral are to provide approval of the referral agreement. In some embodiments, the RAS automatically obtains approval of the agreement from the one or more brokers based on selected criteria, such as in response to a determination that the one or more brokers are to provide approval of the referral agreement.

At act 1708, the RAS generates, and causes to be transmitted, one or more messages to one or more users associated with the referral that include an indication that the referral agreement has been signed.

At act 1709, the RAS includes information regarding the referral in a user interface that indicates one or more referrals associated with a user. In some embodiments, the RAS updates the user interface in response to any one or more of the acts included in the process to use a referral agreement system. In some embodiments, the RAS updates the user interface in real-time.

At act 1710, the process to use a referral agreement system ends.

In some embodiments, the RAS applies one or more data security access standards to data associated with the referral. In some embodiments, the RAS generates one or more electronic forms able to receive one or more e-signatures as part of the process to use a referral agreement system. In some embodiments, the RAS applies one or more referral fees to the referral agreement, such as a referral fee imposed by one or more brokerages.

In some embodiments, the RAS includes one or more internal search systems or platforms for searching for users to be referred. In some embodiments, the RAS includes one or more transaction, referral, etc., monitoring platforms or systems, such as Skyslope. In some embodiments, the RAS is able to search for users in multiple geographic areas, such as multiple countries. In some embodiments, the RAS is able to search for users associated with one or more types of real estate, such as commercial real estate, residential real estate, etc. In some embodiments, the RAS is able to search for brokerages that are not associated with the facility.

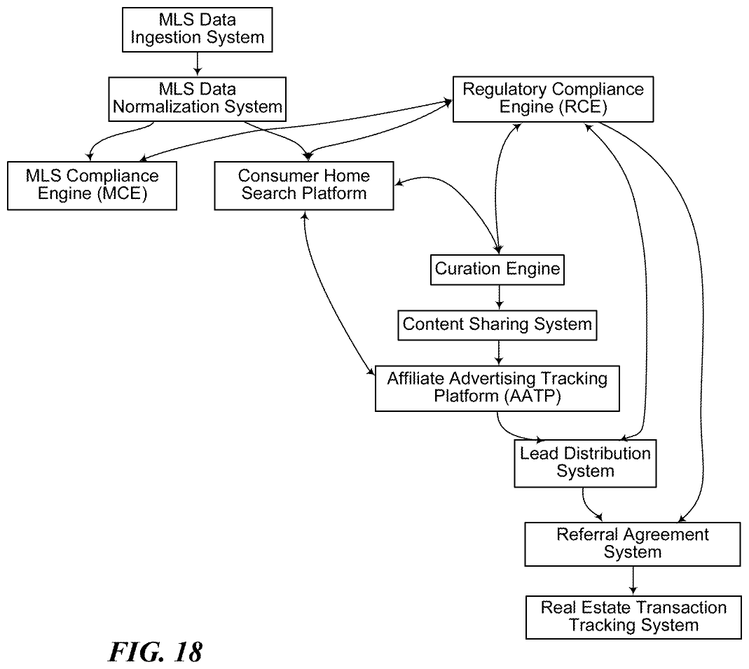

FIG. 18 is a sample block diagram of various systems, functions, components, services, etc., of the facility, including a real estate tracking system (“RETTS”), used by the facility in some embodiments. In some embodiments, the RETTS presents one or more interfaces that present an indication of one or more transaction milestones of one or more transactions. In some embodiments, the RETTS includes one or more services, functions, processes, systems, components, etc., that determine whether a transaction meets one or more compliance requirements. In some embodiments, the RETTS includes data used to create or curate content via a CCE, such as the CCE described above with respect to FIGS. 14 and 15. In some embodiments, the RETTS includes data used to prioritize content accessed by a CSS, such as the CSS described above with respect to FIG. 16.

In some embodiments, the RETTS receives input updating one or more transactions from one or more users. In such embodiments, the RETTS may use the received input to ensure accuracy of transaction data, address discrepancies in transaction data, etc. In some embodiments, the RETTS includes one or more data privacy components, data security components, or some combination thereof.

In some embodiments, the RETTS stores historical transaction data. In some embodiments, the RETTS uses the historical transaction data to analyze, detect, or otherwise identify one or more trends. In some embodiments, the RETTs uses the historical transaction data to asses, detect, generate, analyze, etc., one or more performance metrics of one or more transactions.

In some embodiments, the RETTS includes a search system for searching for one or more users. In some embodiments, the RETTS includes one or more systems or processes that automate one or more stages of a transaction, such as stages that involve interaction with a client.

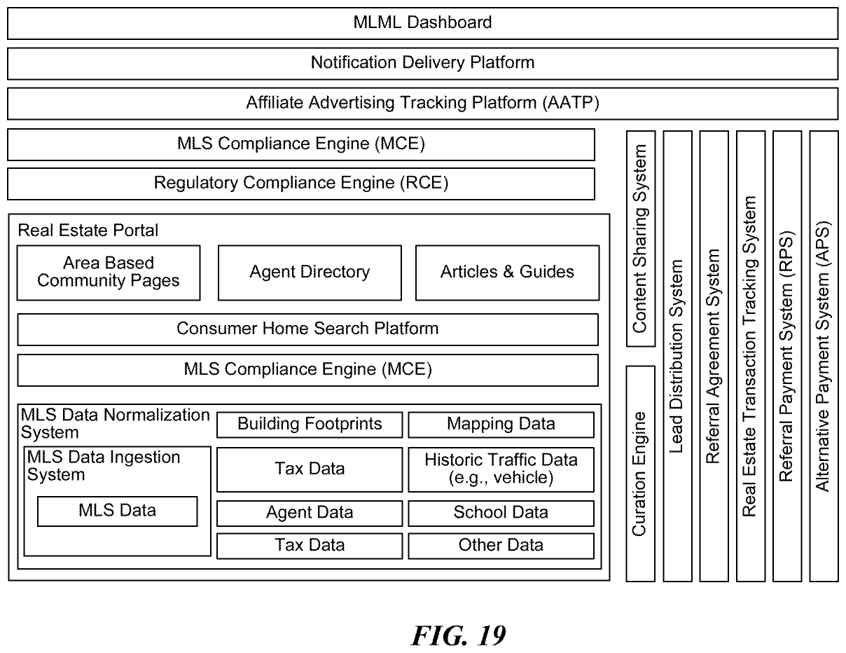

FIG. 19 is a sample block diagram of an embodiment of the facility that includes one or more of: a dashboard, a notification delivery platform, an affiliate advertising tracking platform, an MCE, an RCE, a CCE, a CSS, a data ingestion system, a data normalization system, an RETTS, an RAS, and other aspects of the facility.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method in a computing system for directing a services referral, the method comprising:
receiving input originated by a prospective referrer specifying one or more rules to be applied to referral opportunities arising for the prospective referrer to select one or more target providers;
storing the specified one or more rules on behalf of the prospective referrer;
determining that a referral opportunity has arisen for the prospective referrer relating to a service opportunity for a consumer;
applying the stored one or more rules to the referral opportunity to select one or more target providers; and
causing the referral opportunity to be conveyed to one or more of the selected one or more target providers.

2. The method of claim 1, further comprising:
receiving responses from two or more of the target providers to whom the referral opportunity was conveyed; and
choosing one of the target providers from whom responses were received as the referral opportunity's recipient.

3. The method of claim 1 wherein the referral opportunities conveyed to a single target provider, the method further comprising:
automatically adding the service opportunity to an actionable service opportunity list maintained for the single target provider.

4. The method of claim 1 wherein the referral opportunities conveyed to a single target provider, the method further comprising:
automatically contacting the consumer on behalf of the single target provider.

5. One or more instances of computer-readable media collective having contents configured to cause a computing system to perform a method, the method comprising:
receiving input originated by a prospective referrer specifying one or more rules to be applied to referral opportunities arising for the prospective referrer to select one or more target providers;
storing the specified one or more rules on behalf of the prospective referrer.

6. The one or more instances of computer-readable media of claim 5, the method further comprising:
determining that a referral opportunity has arisen for the prospective referrer relating to a service opportunity for a consumer;
applying the stored one or more rules to the referral opportunity to select one or more target providers; and
causing the referral opportunity to be conveyed to one or more of the selected one or more target providers.

7. The one or more instances of computer-readable media of claim 5 wherein the received input comprises a logical rule for selecting one or more target providers.

8. The one or more instances of computer-readable media of claim 5 wherein the received input selects among a plurality of predefined rules each for selecting one or more target providers.

9. The one or more instances of computer-readable media of claim 5 wherein the received input comprises a list of providers preferred by the prospective referrer.

10. One or more instances of computer-readable media collectively storing a data structure, the data structure comprising:
a plurality of entries, each entry corresponding to a different prospective referrer among a plurality of prospective referrers and comprising:
first information identifying the prospective referrer; and
second information obtained from the prospective referrer that specifies a manner in which to select, for a referral opportunity by the prospective referrer, one or more target providers to whom to direct the referral,
such that the contents of the data structure are usable to, for a distinguished referral opportunity arising for a distinguished prospective referrer among the plurality of prospective referrers, identify the entry whose first information identifies the distinguished prospective referrer, and using the second information of the identified entity to automatically select one or more target providers to whom to direct the distinguished referral.

11. The one or more instances of computer-readable media of claim 10 wherein, for each of at least a portion of the plurality of entries, the second information comprises a logical rule for selecting one or more target providers.

12. The one or more instances of computer-readable media of claim 10 wherein, for each of at least a portion of the plurality of entries, the second information comprises a reference to a predefined rule for selecting one or more target providers.

13. The one or more instances of computer-readable media of claim 10 wherein, for each of at least a portion of the plurality of entries, the second information comprises a list of providers preferred by the prospective referrer identified by the entry's first information.

14. The one or more instances of computer-readable media of claim 10 wherein each of at least a portion of the plurality of entries further comprises third information specifying a basis for establishing an order among the selected target providers.

15. The one or more instances of computer-readable media of claim 10 wherein, each of at least a portion of the plurality of entries further comprises third information specifying a mode in which to solicit selected target providers.

16. The one or more instances of computer-readable media of claim 10 wherein, each of at least a portion of the plurality of entries further comprises third information obtained from a source other than the prospective referrer that specifies a manner in which to select, for a referral opportunity by the prospective referrer, one or more target providers to whom to direct the referral.

17. A method in a computing system for directing a services referral, the method comprising:
determining that a referral opportunity has arisen for a prospective referrer relating to a service opportunity for a consumer;
accessing one or more rules specified on behalf of the prospective referrer;
applying the accessed one or more rules to the referral opportunity to select one or more target providers; and
causing the referral opportunity to be conveyed to one or more of the selected one or more target providers.

18. The method of claim 17, further comprising:
receiving responses from two or more of the target providers to whom the referral opportunity was conveyed; and
choosing one of the target providers from whom responses were received as the referral opportunity's recipient.

19. The method of claim 17 wherein the referral opportunities conveyed to a single target provider, the method further comprising:
automatically adding the service opportunity to an actionable service opportunity list maintained for the single target provider.

20. The method of claim 17 wherein the referral opportunities conveyed to a single target provider, the method further comprising:
automatically contacting the consumer on behalf of the single target provider.
